(19) United States
(12) Patent Application Publication
(10) Pub. No.: US 2015/0354711 A1
(43) Pub. Date: Dec. 10, 2015

(54) KNIFE GATE VALVE

(71) Applicant: ORBINOX VALVES INTERNATIONAL., S. L., Anoeta (Guipúzcoa) (ES)

(72) Inventor: Manuel PALOMEQUE, Anoeta (Guipúzcoa) (ES)

(21) Appl. No.: 14/761,778

(22) PCT Filed: Jan. 21, 2013
(86) PCT No.: PCT/ES2013/070020

§ 371 Date: Jul. 17, 2015

(51) Int. Cl. F16K 3/02

(52) U.S. Cl. CPC F16K 3/0281; F16K 3/0218

(57) ABSTRACT

Knife gate valve comprising a body (1) having an upper part comprising a flat notch (2) for the passage of a gate (4) and having a lower part including an opening (3), and the flat notch (2) traverses the body (1) from the upper part to the opening (3). The valve comprises a sleeve (5) in the interior of the opening (3) comprising a groove (6) coinciding with the flat notch (2) in the upper part of the opening (3), and has a section comprising a central core (7). The valve further has of a pair of fastening rings (8) placed on both sides of the valve body (1) which have an inner section complementary to the section of the sleeve (5).

### OBJECT OF THE INVENTION

The present invention is included in the technical field of knife gate valves. In particular, the present invention proposes a valve comprising a sleeve especially designed to allow the correct sealing of the closure without making a channel in the valve body for its placement.

### BACKGROUND OF THE INVENTION

Knife gate valves are designed for the interruption and/or regulation of the passage of a fluid. This type of valves comprises a gate therein, this gate being the closing element and which allows the closure and opening of an opening made in the valve body, wherethrough the corresponding fluid passes.

A type of knife gate valves called knife gate valves of unidirectional closure are known in the state of the art. These comprise a sleeve situated concentric with the orifice for the passage of fluid, and the sleeve is positioned in parallel with said orifice. Thus, when the gate is in the closed valve position, i.e. plugging the fluid through-hole, the sleeve is in frontal contact with the gate. In these valves the sleeve is only in contact with one face of the gate.

Another type of valves known in the state of the art are knife gate valves called bidirectional. These valves comprise a sleeve with a semi-circumference form which lies in the lower part of the valve, in the area between the end of the gate that displaces closing the orifice, and the interior of the valve body where it makes contact to close said orifice. The sleeve or seal is peripheral and is always in contact with the gate whilst it moves.

A technical problem that the two designs described share is the need to make an inner channel in the valve opening area. In the first case, a circular inner channel is necessary, which has a perimeter slightly greater than that of the opening and which is situated in parallel to said opening. In the second case, it is necessary to make a channel in the lower part of the opening in the interior whereof the sleeve is trapped when the opening is closed with the gate. To make this channel, specific machining means are necessary, in particular cutter bar-type machining. The sleeve is placed on this channel when the gate closes, it presses on the sleeve, making it fit into the groove and thus guaranteeing the sealing.

An important disadvantage of the knife gate valves of the state of the art is precisely this channel which must be machined in the inner part of the opening, since it can be filled with dirt and residues can accumulate in it.

### DESCRIPTION OF THE INVENTION

The present invention resolves the mentioned technical problem by a hybrid knife gate valve which performs a double front closure in the first part of the closure path and a peripheral-type closure in the second part of the path, when valve closure is completed.

The valve body has an upper part wherein there is a flat notch which serves as passage for a gate which acts as closing element of the valve. Said flat notch extends to a lower part of the valve body wherein there is an opening for the passage of fluid.

The double front closure occurs in the upper part of the opening. It is achieved having the valve gate surrounded by a sleeve, which guarantees the sealing of the closure, situated on both sides of the gate. Thus, the sleeve performs pressure from both sides of the gate.

The peripheral closure occurs in the lower part of the opening. It is achieved having the sleeve comprising a section with a central core which is the contact surface of the gate in the closed valve position. In an embodiment of the invention this central core may have a contour coinciding with the contour of the gate end.

Hence, the valve of the present invention combines the advantages of the different closure systems of knife gate valves known in the state of the art. Another important advantage of the design of this valve is that the valve opening does not have inner channels for the placement of the sleeve but it is the actual sleeve which has a specially designed section to make it possible to obtain the two types of aforementioned closures.

The sleeve of the present invention is completely adapted to the valve body opening. Additionally, the sleeve comprises a groove which coincides with the flat notch in the upper part of the opening, allowing the passage of the gate therethrough. The sleeve section comprises a central core from which recesses emerge on both sides.

The valve comprises a pair of fastening rings which are positioned following the contour of the valve opening. Said additional elements fix the sleeve to the valve body and they also act as decorative element as they protrude from the lateral faces of the body. In their final position they are separated from one another by the gate.

### DESCRIPTION OF THE DRAWINGS

To complement the description being made and in order to aid towards a better understanding of the characteristics of the invention, in accordance with a preferred example of practical embodiment thereof, a set of drawings is attached as an integral part of said description wherein, with illustrative and non-limiting character, the following has been represented:

FIG. 1.—Shows an exploded view of the present valve wherein all its component elements can be observed.

FIG. 2.—Shows a sectional view of the knife gate valve of the present invention.

### PREFERRED EMBODIMENT OF THE INVENTION

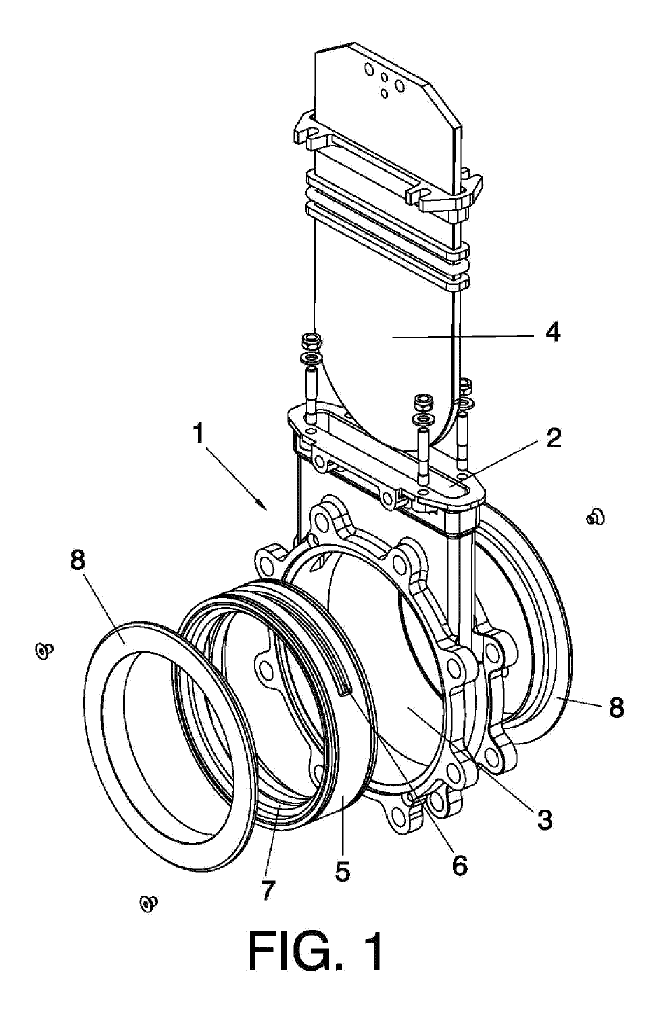

A detailed description of a preferred embodiment of the invention is described below with the aid of FIGS. 1 to 3 mentioned above.

The knife gate valve of the present invention is hybrid and comprises in the first part of the closure path of the gate, a double front closure, and in the second part of the path, when the closure of the opening is completed, a peripheral-type closure.

In general terms, the knife gate valve of the present invention comprises a body (1) which has an upper part including a flat notch (2) for the passage of a gate (4) which acts as closing element and has a lower part including an opening (3). Said flat notch (2) traverses the body (1) from the upper part to the opening (3). The most important characteristic of the valve is that it comprises a sleeve (5) in the interior of the opening (3) comprising a groove (6) coinciding with the flat notch (2) in the upper part of the opening (3) and the section whereof comprises a central core (7). In a preferred embodiment said sleeve (5) has recesses on both sides of said central core (7). The valve has a pair of fastening rings (8) which are identical and which are placed on both sides of the valve body (1), covering the perimeter of the opening (3) and which have an inner section complementary to the section of the sleeve (5). FIG. 1 shows an exploded view of the present valve wherein all its component elements can be observed.

The flat notch (2) traverses the valve body (1) from the upper part to the opening (3). The valve further comprises joining means which allow its joining to pipes or receptacles between which the valve is positioned in each specific case. An important characteristic of the valve of the present invention is that it does not include inner channels in the opening (3).

The gate (4) of the present valve is a flat piece which allows opening or closing the opening (3) to control the passage of a fluid, moving longitudinally through the flat notch (2). In a preferred embodiment, the gate (4) has a semicircular end.

The valve of the present invention fundamentally stands out due to the sleeve (5), which makes it possible to perform a double front closure and a peripheral closure in the valve. This sleeve (5) has a circumferential form and is placed covering the inner perimeter of the valve opening (3). The outer part of the sleeve (5) is a flat surface, coinciding with the flat surface of the interior of the opening (3).

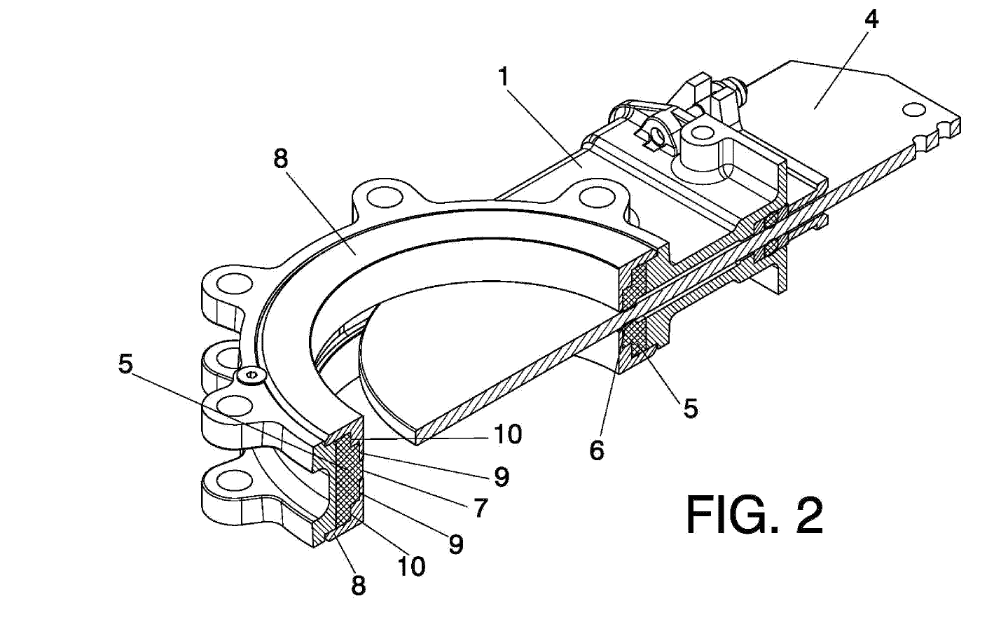

The double front closure of the valve is achieved in the upper part of the opening (3) due to action of the peripheral edge of the groove (6) through the interior whereof passes the gate (4), so that the gate (4) is interlocked, in its displacement, between part of the sleeve (5) on one side of the groove (6), which presses in one direction, and part of the sleeve (5) on the other side of the groove (6), which presses in the other direction. The peripheral-type closure is achieved in the lower part of the opening (3) where the total closure of the valve occurs when the end of the gate (4) comes into contact with the central core (7) of the sleeve (5). FIG. 2 shows the areas of contact between the sleeve (5) and the gate (4).

The knife gate valve of the present invention further comprises a pair of fastening rings (8). These fastening rings (8) are identical to one another and are placed one on either side of the valve body (1), covering the perimeter of the opening (3). The function of the fastening rings (8) is to guarantee the fixing of the sleeve (5) in its position to the valve body (1). The inner section of the fastening rings (8) is complementary to the section of the sleeve (5) and they have a projecting section which lies over the lateral faces of the valve body (1). The fastening rings (8) are separated from one another by the gate (4).

In a preferred embodiment of the invention, the sleeve (5) has two recesses on different sides of the central core (7), as can be observed in FIG. 2. Thus, the sleeve (5) comprises a first recess (9) on both sides of the central core (7) and comprises a second recess (10) beside the first recess (9). The inner section of the fastening rings (8) is complementary with the section of the sleeve (5) for which reason in this embodiment, the inner section of the fastening rings comprises a first projection corresponding to the first recess (9) and a second projection corresponding to the second recess (10).

1. Knife gate valve of the type comprising a body having an upper part including a flat notch for the passage of a gate which acts as closing element, and having a lower part including an opening and where the flat notch traverses the body from the upper part to the opening, and the valve is characterized in that it is formed in a unique body free of internal channels so the surface of the interior of the opening is flat and it comprises:
a sleeve in the interior of the opening comprising a groove coinciding with the flat notch in the upper part of the opening, and the section of said sleeve comprises a central core which is the contact surface with the gate in closed valve position, and the surface of the interior of the opening is flat and the outer part of the sleeve is a flat surface coinciding with the flat surface of the interior of the opening; and
the valve further has a pair of fastening rings which are identical and which are placed on both sides of the valve body, covering the perimeter of the opening and which have an inner section complementary to the section of the sleeve, and which are separated from one another by the gate in closed valve position.

2. Valve according to claim 1, wherein the sleeve has recesses on both sides of the central core.

3. (canceled)

4. Valve according to claim 2, wherein the sleeve comprises a first recess on both sides of the central core and comprises a second recess beside the first recess.

5. Valve according to claim 4, wherein the inner section of the fastening rings comprises a first projection corresponding to the first recess and a second projection corresponding to the second recess.
